(19) United States
(12) Patent Application Publication
(10) Pub. No.: US 2026/0166501 A1
(43) Pub. Date: Jun. 18, 2026

(54) AGITATION/TRANSFER METHOD AND AGITATION/TRANSFER DEVICE

(71) Applicant: The University of Osaka, Suita-shi, Osaka (JP)

(72) Inventors: Susumu GOTO, Suita-shi, Osaka (JP); Daiki WATANABE, Suita-shi, Osaka (JP); Kento EGUCHI, Suita-shi, Osaka (JP)

(21) Appl. No.: 19/124,966

(22) PCT Filed: Oct. 30, 2023
(86) PCT No.: PCT/JP2023/039093

§ 371 Date: Apr. 28, 2025

(30) Foreign Application Priority Data
Nov. 9, 2022 (JP) 2022-179637

(51) Int. Cl. B01F 29/25; B01F 23/43; B01F 23/53; B01F 29/62

(52) U.S. Cl. CPC B01F 29/252; B01F 23/43; B01F 23/53; B01F 29/62; B01F 2215/0431; B01F 2215/0459

(57) ABSTRACT

An agitation/transfer method includes: preparing a transfer pipe extending in a horizontal extending direction; causing at least one type of liquid to be agitated and transferred to flow and be transferred in the transfer pipe at Reynolds number in a predetermined range and a filling ratio in a predetermined range; and agitating the at least one type of liquid by rotating the transfer pipe about the extending direction and generating a vortex street in the at least one type of liquid.

### TECHNICAL FIELD

The present invention relates to an agitation/transfer method and an agitation/transfer device.

### BACKGROUND ART

As one of methods for transferring liquid while agitating the liquid, a static mixer is known. In the static mixer, an agitating part having a complicated shape is installed inside a transfer pipe to induce a complicated flow of liquid, thereby promoting agitation. For example, such a static mixer is disclosed in Patent Documents 1 and 2.

### PRIOR ART DOCUMENTS

### Patent Documents

Patent Document 1: JP-A-2011-121038
Patent Document 2: JP-A-2022-62345

### SUMMARY OF THE INVENTION

### Problems to be Solved by the Invention

Since the static mixer requires an agitating part having a complicated shape in the transfer pipe, the static mixer lacks cleanability. In addition, since the only parameter that can be operated is the flow rate, controllability regarding the agitation/transfer of the liquid is also lacking.

An object of the present invention is to realize agitation/transfer with good cleanability and controllability in an agitation/transfer method and an agitation/transfer device.

### Solutions to the Problems

A first aspect of the present invention provides an agitation/transfer method including:
preparing a transfer pipe extending in a horizontal extending direction;
causing at least one type of liquid to be agitated and transferred to flow and be transferred in the transfer pipe at Reynolds number in a predetermined range and a filling ratio in a predetermined range; and
agitating the at least one type of liquid by rotating the transfer pipe about the extending direction and generating a vortex street in the at least one type of liquid.

According to this method, it is not necessary to install an agitating part having a complicated shape in the transfer pipe, and at least one type of liquid can be agitated by rotation of the transfer pipe. Therefore, good cleanability can be secured. Upon agitation, a vortex street with a rotation axis perpendicular to the flow direction is generated. Adjacent vortices in the vortex street swirl in opposite directions to each other, and agitation is achieved by the vortex street. In addition, not only the flow rate (transfer velocity) of at least one type of liquid but also the rotation velocity of the transfer pipe is a parameter that can be adjusted. Therefore, by adjusting the transfer velocity and the rotation velocity, the agitation/transfer can be suitably controlled, and appropriate agitation/transfer can be realized according to the process to be performed. Here, the term “horizontal” means not only strict horizontal but also substantially horizontal, and for example, an inclination of at least about several degrees from the horizontal direction is allowed. In addition, at least one type of liquid includes a mixed phase flow of gas or a solid and liquid.

In the agitation/transfer method, the filling ratio in the predetermined range may be 10% or more and 90% or less.

According to this method, by defining the filling ratio, generation of a stable vortex street can be realized, and stable agitation can be realized. The effectiveness of the filling ratio range was confirmed by numerical simulation.

In the agitation/transfer method, a shape of a cross section perpendicular to the extending direction of the transfer pipe may be circular.

According to this method, a smooth inner surface of the transfer pipe can be formed, and stable agitation can be realized. Here, the diameter of the transfer pipe may be constant or may vary.

In the agitation/transfer method, the transfer pipe may be a circular pipe having a constant diameter.

According to this method, a simple circular-pipe-shaped transfer pipe can be used, so that manufacturing and installation are facilitated.

In the agitation/transfer method, the transfer pipe may have a length of 0.6 times or more a circular diameter of a cross section perpendicular to the extending direction.

According to this method, by specifically defining the ratio between the length and the diameter of the transfer pipe (aspect ratio), it may be possible to realize stable generation of a vortex street, and it may be possible to realize stable agitation. Note that, the effectiveness of the range of the aspect ratio depends on the filling ratio and the Reynolds number, but the simulation was actually performed, and the generation of the vortex street was confirmed at the aspect ratio.

In the agitation/transfer method, the Reynolds number in the predetermined range may be 98 or more.

According to this method, by defining the Reynolds number, it may be possible to realize generation of a vortex street, and it may be possible to realize stable agitation. Although the effectiveness of the range of the Reynolds number depends on the filling ratio, simulation was actually performed to confirm generation of a vortex street at the Reynolds number.

In the agitation/transfer method, the at least one type of liquid to be agitated and transferred may contain particles, the Stokes number in the agitation may be 2.7×10⁻⁵ or more, and ratio between terminal velocity of free fall of the particles and inner wall surface velocity in a rotation direction of the transfer pipe may be −0.01 or more and 0.52 or less.

According to this method, the particles can be aggregated with agitation. For the effectiveness of the particle aggregation conditions, a numerical simulation was actually performed to confirm the density of the particle field.

A second aspect of the present invention provides an agitation/transfer device including:
a transfer pipe that extends in a horizontal extending direction and causes at least one type of liquid to be agitated and transferred to flow and be transferred at a filling ratio in a predetermined range and Reynolds number in a predetermined range; and
a rotation mechanism that agitates the at least one type of liquid by rotating the transfer pipe about the extending direction and generating a vortex street in the at least one type of liquid.

In the agitation/transfer device, the filling ratio in the predetermined range may be 10% or more and 90% or less.

In the agitation/transfer device, a shape of a cross section perpendicular to the extending direction of the transfer pipe may be circular.

In the agitation/transfer device, the transfer pipe may be a circular pipe having a constant diameter.

In the agitation/transfer device, the transfer pipe may have a length of 0.6 times or more a circular diameter of a cross section perpendicular to the extending direction.

In the agitation/transfer device, the Reynolds number in the predetermined range may be 98 or more.

In the agitation/transfer device, the at least one type of liquid to be agitated and transferred may contain particles, the Stokes number in the agitation may be 2.7×10⁻⁵ or more, and the ratio between terminal velocity of free fall of the particles and inner wall surface velocity in a rotation direction of the transfer pipe may be −0.01 or more and 0.52 or less.

### Effects of the Invention

According to the present invention, in the agitation/transfer method and the agitation/transfer device, the present invention can realize agitation/transfer with good cleanability and controllability.

### BRIEF DESCRIPTION OF THE DRAWINGS

FIG. 1 is a schematic configuration diagram of an agitation/transfer device according to an embodiment of the present invention;

FIG. 2 is a photograph of an experimental result showing a vortex street in stationary liquid;

FIG. 3 is a vector diagram of a flow field of a numerical simulation result showing a vortex street in stationary liquid;

FIG. 4 is a vector diagram of a flow field of a numerical simulation result showing a vortex street at a time of 0 second in flowing liquid;

FIG. 5 is a vector diagram of a flow field of a numerical simulation result showing a vortex street at a time of 4 seconds in flowing liquid;

FIG. 6 is a vector diagram of a flow field of a numerical simulation result showing a vortex street at a time of 8 seconds in flowing liquid;

FIG. 7 is a vector diagram of a flow field of a numerical simulation result showing a vortex street at a filling ratio of 10%;

FIG. 8 is a vector diagram of a flow field of a numerical simulation result showing a vortex street at a filling ratio of 90%;

FIG. 9 is a vector diagram of a flow field of a numerical simulation result showing a vortex street at Reynolds number of 100;

FIG. 10 is a vector diagram of a flow field of a numerical simulation result showing a vortex street when the length of the transfer pipe is 0.6 times the diameter;

FIG. 11 is a first graph of a numerical simulation result showing the relationship between the strength of the circulating flow and ratio K1 (average flow velocity/inner wall surface velocity);

FIG. 12 is a second graph of a numerical simulation result showing the relationship between the strength of the circulating flow and the ratio K1 (average flow velocity/inner wall surface velocity);

FIG. 13 is a diagram showing a particle field when particles are initially arranged in the numerical simulation regarding the Stokes number;

FIG. 14 is a diagram showing a particle field when the Stokes number is 9.5×10⁻⁶;

FIG. 15 is a diagram showing a particle field when the Stokes number is 2.7×10⁻⁵;

FIG. 16 is a diagram showing a particle field when the Stokes number is 1.1×10⁻⁵;

FIG. 17 is a diagram showing a particle field when the Stokes number is 4.2×10⁻⁴;

FIG. 18 is a diagram showing a particle field when the Stokes number is 1.7×10⁻³;

FIG. 19 is a diagram showing a particle field when particles are initially arranged in a numerical simulation regarding ratio between terminal velocity of free fall of particles and inner wall surface velocity in a rotation direction of a transfer pipe.

FIG. 20 is a diagram showing a particle field when the ratio between the terminal velocity of free fall of particles and the inner wall surface velocity of the transfer pipe in the rotation direction is −0.02;

FIG. 21 is a diagram showing a particle field when the ratio between the terminal velocity of free fall of particles and the inner wall surface velocity of the transfer pipe in the rotation direction is −0.0068;

FIG. 22 is a diagram showing a particle field when the ratio between the terminal velocity of free fall of particles and the inner wall surface velocity of the transfer pipe in the rotation direction is 0.068;

FIG. 23 is a diagram showing a particle field when the ratio between the terminal velocity of free fall of particles and the inner wall surface velocity of the transfer pipe in the rotation direction is 0.27;

FIG. 24 is a diagram showing a particle field when the ratio between the terminal velocity of free fall of particles and the inner wall surface velocity of the transfer pipe in the rotation direction is 0.55; and

FIG. 25 is a graph showing a relationship between Nε/Nₚ (the proportion of particles in the vicinity of a wall surface or a liquid surface of the transfer pipe) and ratio K2 (terminal velocity of free fall of particles/inner wall surface velocity in a rotation direction of the transfer pipe).

### DETAILED DESCRIPTION

Hereinafter, embodiments of the present invention will be described with reference to the accompanying drawings.

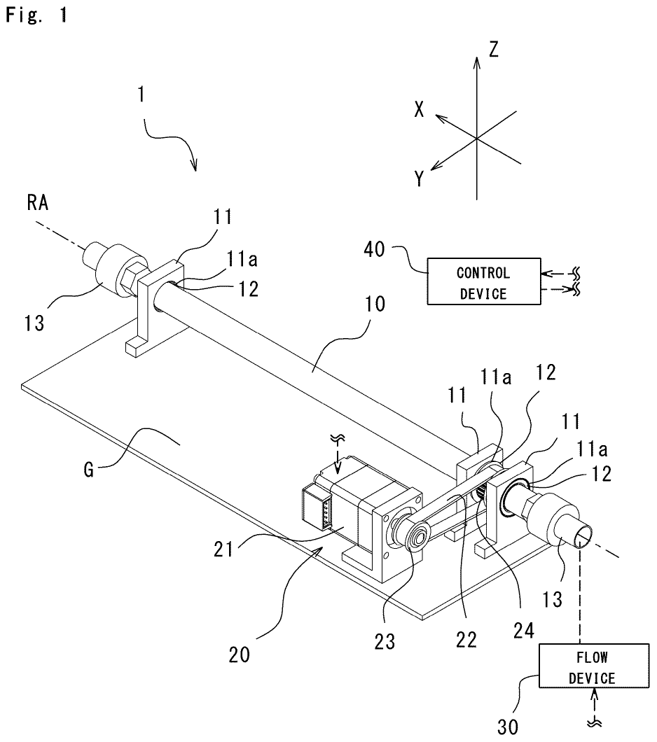

An agitation/transfer device 1 of the present embodiment shown in FIG. 1 transfers liquid while agitating the liquid. An X direction indicates an extending direction of a transfer pipe 10 (in the present embodiment, the extending direction coincides with the extending direction of a rotation axis RA) in a horizontal plane, a Y direction indicates a direction orthogonal to the X direction in the horizontal plane, and a Z direction indicates a vertical direction (up and down direction).

The configuration of the agitation/transfer device 1 will be described.

The agitation/transfer target can be at least one type of arbitrary liquid. The at least one type of arbitrary liquid includes not only liquid alone but also a mixed phase flow of gas or a solid and liquid. For example, water alone, water and oil (mixed phase flow of liquid and liquid) in emulsification, monomer, polymer, and water in polymerization reaction process, slurry agitation (mixed phase flow of a solid and liquid) in catalytic reaction process, single phase or multiphase non-Newtonian fluid (pseudoplastic fluid or plastic fluid), aeration agitation of oxygen such as a bioreactor (mixed phase flow of gas and liquid), mixed phase flow of a solid (mud, etc.) and liquid in an anaerobic layer such as a bioreactor, or the like can be targeted. In addition, the solid may be a particle. The particles can also be aggregated by agitating the particles in liquid.

The agitation/transfer device 1 includes the transfer pipe 10 for transferring liquid to be agitated and transferred, and a rotation mechanism 20 for agitating the liquid by rotating the transfer pipe 10. In the present embodiment, the agitation/transfer device 1 includes a flow device 30 for causing liquid to flow, and a control device 40 for controlling each unit.

In the present embodiment, the transfer pipe 10 is a circular pipe extending in a horizontal extending direction and having a uniform thickness. The transfer pipe 10 has a smooth inner surface and does not have an additional configuration such as an agitating part with a complex shape therein. Therefore, the transfer pipe 10 is excellent in cleanability.

Preferably, the transfer pipe 10 has a length of 0.6 times or more the circular diameter of the cross section perpendicular to the extending direction. The validity of such a numerical range will be de scribed later in detail. In addition, the material of the transfer pipe 10 can be arbitrarily set.

In the present embodiment, the transfer pipe 10 is lifted from a floor surface G by a plurality of support members 11 erected on the floor surface G. Each of the plurality of support members 11 has a through hole 11a and a bearing 12 attached to the through hole 11a. The transfer pipe 10 passes through the through hole 11a and is held by the support member 11 so as to be rotatable about the rotation axis RA via the bearing 12.

In the present embodiment, connection components 13 are attached to both ends of the transfer pipe 10 in the extending direction. The connection component 13 is for connection with a general pipe (not shown). In this manner, the transfer pipe 10 can be connected to an existing general pipe. Therefore, the agitation/transfer device 1 has high versatility.

The rotation mechanism 20 is mechanically connected to the transfer pipe 10 and rotates the transfer pipe 10 about the rotation axis RA. In the present embodiment, the rotation mechanism 20 includes a motor 21 serving as a drive source, a belt 22 that transmits a force from the motor 21, and pulleys 23 and 24. The pulley 23 is attached to the motor 21, the pulley 24 is attached to the transfer pipe 10, and the belt 22 is stretched between the pulleys 23 and 24.

When the motor 21 is driven, the rotational force of the motor 21 is transmitted to the transfer pipe 10 via the belt 22 and the pulleys 23 and 24, and the transfer pipe 10 is rotated about the rotation axis RA. In the present embodiment, the rotation axis RA and the central axis of the transfer pipe 10 coincide with each other.

The flow device 30 is a device for adjusting flow velocity or a flow rate (transfer velocity) of the liquid. The flow device 30 is, for example, a known pump. However, an aspect of the flow device 30 is not particularly limited, and the flow device 30 may take any aspect.

The control device 40 performs arithmetic processing and control of the entire device. In the present embodiment, the control device 40 includes hardware such as a central processing unit (CPU), a random access memory (RAM), and a read only memory (ROM), and software mounted on the hardware.

In the present embodiment, the control device 40 controls the rotation mechanism 20 to adjust the rotation velocity of the transfer pipe 10 about the rotation axis RA. In addition, the control device 40 controls the flow device 30 to adjust the average flow velocity of the liquid in the extending direction of the transfer pipe 10.

The liquid to be agitated and transferred flows in the transfer pipe 10 at Reynolds number Re in a predetermined range and a filling ratio F in a predetermined range. Here, the Reynolds number Re is a value represented by density p of the liquid, a radius R of the transfer pipe 10, rotation velocity ω of the transfer pipe 10, and viscosity u of the liquid (Re=ρR²ω/μ). The filling ratio F is a value represented by the proportion (%) of volume V of the liquid in the transfer pipe 10 to volume C of the transfer pipe 10 (F=100×V/C).

Preferably, the filling ratio F in the predetermined range is 10% or more and 90% or less (10≤F≤90). In addition, preferably, the Reynolds number Re in the predetermined range is 98 or more (Re≥98). Such a numerical range is achieved by the control of the control device 40. The validity of such a numerical range will be de scribed later in detail.

Next, the agitation/transfer method of the present embodiment will be described.

In the agitation/transfer method of the present embodiment, the agitation/transfer device 1 is prepared, and the liquid to be agitated and transferred flows into the transfer pipe 10. At this time, assume that the filling ratio of the liquid in the transfer pipe 10 is, for example, 10% or more and 90% or less. Therefore, a layer of liquid and air exists in the transfer pipe 10.

After the liquid flows into the transfer pipe 10, the transfer pipe 10 is rotated about the rotation axis RA by the rotation mechanism 20. At this time, the Reynolds number Re is, for example, 98 or more (Re≥98). The rotation velocity or the flow rate may be constant or may vary slightly. In the present embodiment, the transfer pipe 10 is rotated at a constant speed, and the liquid is caused to flow at a constant flow rate.

When the transfer pipe 10 is rotated about the rotation axis RA by the rotation mechanism 20, the liquid is transferred while being agitated in the transfer pipe 10. This agitation is due to the generation of a vortex street in the liquid. Although the principle behind the generation mechanism such a vortex street is scientifically non-trivial, the generation of the vortex street enables efficient agitation of the liquid.

An experiment for confirming generation of the vortex street will be described.

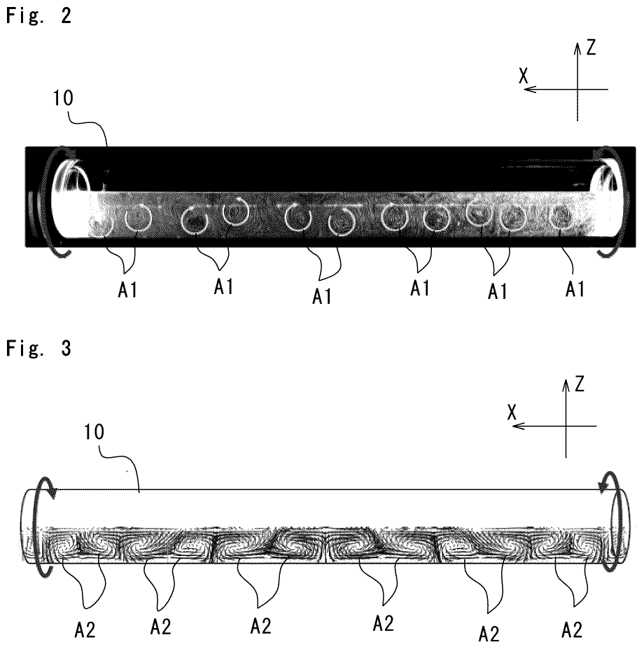

FIG. 2 is a photograph of an experimental result showing the vortex street in stationary liquid. FIG. 2 is a result of observing the state of agitation of the liquid from the side (Y direction) of the transfer pipe 10.

In the experiment, a circular pipe having a diameter of 100 mm and a length of 800 mm was prepared as the transfer pipe 10. The transfer pipe 10 was made of transparent acrylic for easy viewing of the inside. In the transfer pipe 10, water was sealed at a filling ratio of 60% (the remaining 40% was air), and mica particles were further put as a visualization agent. The rotation velocity of the transfer pipe 10 was set to 3 rpm. In the experiment, unlike the present embodiment, the flow velocity of water of the transfer pipe 10 in the extending direction (X direction) was set to 0, that is, water in a stationary state was targeted.

As shown in FIG. 2, a vortex street having a rotation axis perpendicular to the extending direction of the transfer pipe 10 was generated in the water in the transfer pipe 10. For clarity of illustration, reference sign A1 indicating the rotation of each vortex of the vortex street is given. Adjacent vortices in the vortex street swirl in opposite directions to each other, and agitation was achieved by the vortex street. That is, by experimentally confirming the generation of the vortex street, it could be confirmed that the agitation device and the agitation method work well.

FIG. 3 is a vector diagram of a flow field of a numerical simulation result showing a vortex street in the stationary liquid. Specifically, FIG. 3 shows a result of performing a numerical simulation under the similar conditions to those in FIG. 2.

In the numerical simulation, in addition to the parameters set in the experiment, various physical property values (for example, density of 1000 [kg/m³] and viscosity of 0.001 [Pa·s]) of water as liquid, gravitational acceleration of 9.8 [m/s²], surface tension of 0 [N/m], and viscosity and density of an air layer were all set to 0.01 times those of water.

As shown in FIG. 3, a vortex street having a rotation axis perpendicular to the extending direction of the transfer pipe 10 was generated in the liquid in the transfer pipe 10. For clarity of illustration, reference sign A2 indicating the rotation of each vortex of the vortex street is given. The vortex street coincides well with the experimental result shown in FIG. 2, and it could be confirmed that the agitation device and the agitation method work well by confirming the generation of the vortex street by numerical simulation.

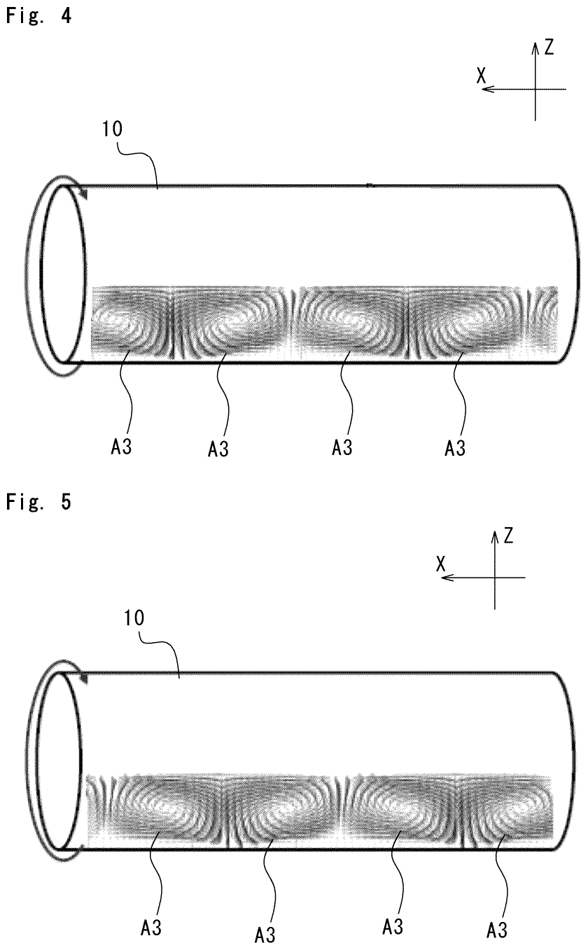

The results of FIGS. 2 and 3 are different from those of the present embodiment in that a stationary liquid (water) is to be agitated, but in the present embodiment, not only agitation but also transfer is simultaneously performed. Therefore, hereinafter, with reference to FIGS. 4 to 6, the results of performing numerical simulations similar to those in FIGS. 2 and 3 for a case where liquid flows in the extending direction of the transfer pipe 10 will be described.

FIGS. 4 to 6 corresponds to the present embodiment, and is a vector diagram of a flow field of a numerical simulation results showing vortex streets at times 0, 4, and 8 seconds in a flowing liquid.

In the numerical simulations, the radius R of the transfer pipe 10 was set to 50 mm, the rotation velocity ω was set to 18 rpm, the filling ratio was set to 40%, and the liquid flow velocity (transfer velocity) was set to 0.012 [m/s], with some changes from the conditions in FIG. 3. In addition, the viscosity u of the liquid was set so that the Reynolds number Re was 200.

Referring to FIGS. 4 to 6, even when the liquid was flowing, a vortex street having a rotation axis perpendicular to the extending direction of the transfer pipe 10 was generated. For clarity of illustration, reference sign A3 indicating the rotation of each vortex of the vortex street is given. In addition, it was confirmed that the vortex street moved together with flow of the liquid. Therefore, even when the liquid is flowing, it could be confirmed that the agitation/transfer device 1 and the agitation/transfer method of the present embodiment are effective by confirming the generation of the vortex street by the numerical simulation.

According to the present embodiment, it is not necessary to install an agitating part having a complicated shape in the transfer pipe 10, and at least one type of liquid can be agitated by rotation of the transfer pipe 10. Therefore, good cleanability can be secured. In addition, not only the flow rate (transfer velocity) of the at least one type of liquid but also the rotation velocity of the transfer pipe 10 is a parameter that can be adjusted. Therefore, by adjusting the transfer velocity and the rotation velocity, the agitation/transfer can be suitably controlled, and appropriate agitation/transfer can be realized according to the process to be performed.

In addition, in the present embodiment, since the transfer pipe 10 is a simple circular pipe, it is easy to manufacture and install.

Hereinafter, preferred ranges of various parameters will be described.

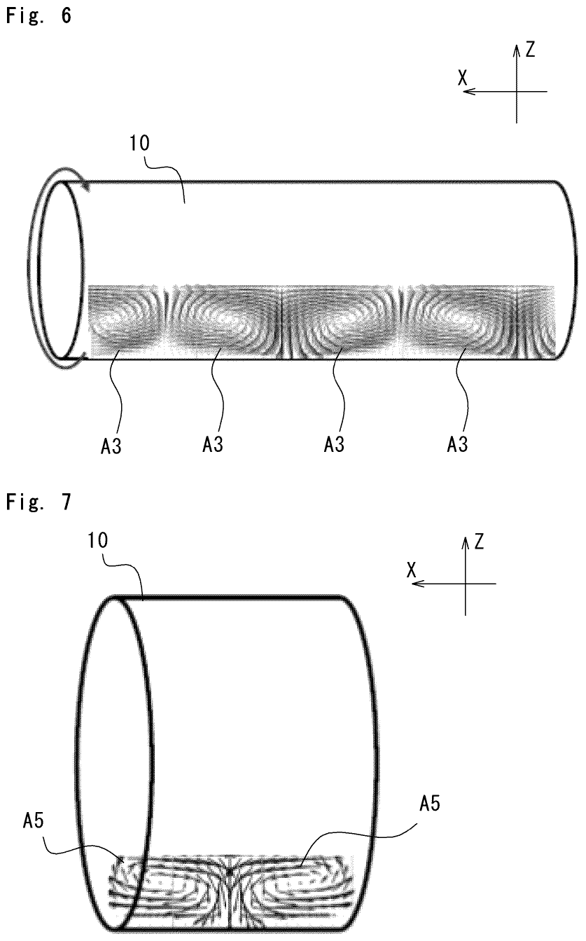

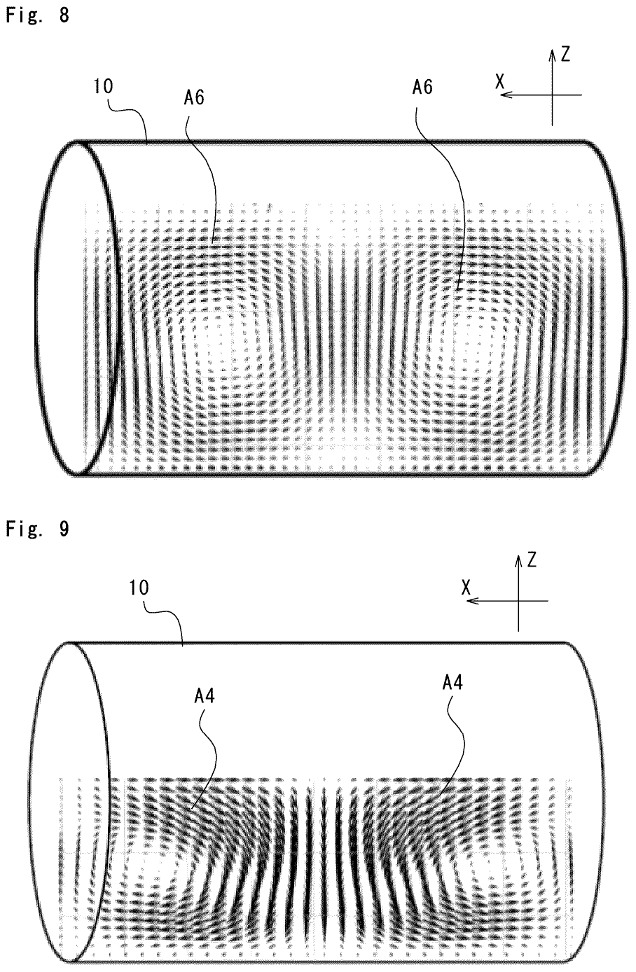

With reference to FIGS. 7 to 8, the result of examining the liquid filling ratio will be described. Specifically, when the filling ratio of the liquid is made too small or too large, the generation of the vortex street may be suppressed, and thus the minimum value and the maximum value of the filling ratio of the liquid were examined. Note that, the numerical simulation of FIG. 7, the viscosity of the liquid was set so that the Reynolds number Re was 500. In the numerical simulation of FIG. 8, the viscosity of the liquid was set so that the Reynolds number Re was 250.

FIG. 7 shows numerical simulation result when the filling ratio is 10%, and FIG. 8 shows numerical simulation result when the filling ratio is 90%. As a result, generation of a vortex street could be confirmed even when the filling ratio was 10% (minimum value) and 90% (maximum value). For clarity of illustration, reference signs A5 and A6 indicating the rotation of each vortex of the vortex street are each given. Therefore, from the results, it could be confirmed that the agitation/transfer device 1 and the agitation/transfer method of the present embodiment are effective when the filling ratio is in the range of 10% to 90%. Therefore, by defining the filling ratio in this way, it is possible to realize generation of a stable vortex street and to realize stable agitation.

With reference to FIG. 9, a result of examining the Reynolds number Re will be described. Specifically, when the Reynolds number Re is too small, generation of a vortex street may be suppressed, and therefore the minimum value of the Reynolds number Re was examined. In addition, since the minimum value of the Reynolds number Re also varies depending on the filling ratio of the liquid, the minimum value was confirmed for each filling ratio.

FIG. 9 shows a numerical simulation result when the Reynolds number Re is 100 at a filling ratio of 60%. The Reynolds number Re was adjusted by changing the viscosity u of the liquid. As a result, generation of a vortex street could be confirmed even when the Reynolds number Re was 100. For clarity of illustration, reference sign A4 indicating the rotation of each vortex of the vortex street is given. Such a simulation was performed while changing the Reynolds number Re and the filling ratio variously to confirm the presence or absence of generation of the vortex street. Table 1 below shows the result of summarizing the minimum Reynolds numbers Re at which the generation of the vortex street could be confirmed for each filling ratio.

TABLE 1

| Filling | Minimum Reynolds |
|---|---|
| ratio (%) | number Re |
| 10 | 326 |
| 20 | 181 |
| 30 | 134 |
| 40 | 122 |
| 50 | 101 |
| 60 | 98 |
| 70 | 193 |
| 80 | 127 |
| 90 | 245 |

From the result shown in Table 1 above, it could be confirmed that the agitation/transfer device 1 and the agitation/transfer method of the present embodiment may be effective (in the case of a filling ratio of 60%) when the Reynolds number Re is 98 or more. Specifically, it could be confirmed that generation of a vortex street may be realized and stable agitation may be realized by defining the Reynolds number Re in this manner. Therefore, the Reynolds number Re may be set to 98 or more. In addition, in order to stably generate vortex streets at all filling ratios of 10% to 90%, the Reynolds number Re may be 326 or more. In addition, Reynolds number Re equal to or larger than the minimum value shown in Table 1 may be appropriately set according to the filling ratio to be set.

With reference to FIG. 10, the result of examining the relationship (aspect ratio) between the length and the diameter of the transfer pipe 10 will be described. Specifically, when the length of the transfer pipe 10 is too small with respect to the diameter, there is a possibility that the generation of a vortex street is suppressed, and thus, the minimum value of the length with respect to the diameter in the transfer pipe 10 was examined. Note that, in the numerical simulation of FIG. 10, the viscosity u of the liquid was set so that the Reynolds number Re was 500, and the filling ratio was set to 10%.

FIG. 10 shows a numerical simulation result when the length of the transfer pipe 10 is 0.6 times the diameter. As a result, generation of the vortex street could be confirmed even when the length of the transfer pipe 10 was 0.6 times the diameter (that is, the aspect ratio was 0.6). For clarity of illustration, reference sign A7 indicating the rotation of each vortex of the vortex street is given. Such a simulation was performed while changing the Reynolds number Re and the filling ratio variously to confirm the presence or absence of generation of the vortex street. Table 2 below shows the result of summarizing the minimum aspect ratio at which the generation of the vortex street could be confirmed for each of the filling ratio and the minimum Reynolds number (see Table 1 above) at the filling ratio.

TABLE 2

| Filling | Minimum Reynolds | Minimum |
|---|---|---|
| ratio (%) | number Re | aspect ratio |
| 10 | 326 | 0.6 |
| 20 | 181 | 0.9 |
| 30 | 134 | 1.1 |
| 40 | 122 | 1.2 |
| 50 | 101 | 1.4 |
| 60 | 98 | 1.5 |
| 70 | 193 | 1.6 |
| 80 | 127 | 1.8 |
| 90 | 245 | 1.8 |

From the result shown in Table 2 above, it could be confirmed that when the length of the transfer pipe 10 is 0.6 times or more the diameter (aspect ratio was 0.6 or more), the agitation/transfer device 1 and the agitation/transfer method of the present embodiment may be effective (in the case of a filling ratio of 10%). Therefore, by specifically defining the ratio of the length to the diameter (aspect ratio) of the transfer pipe 10 in this manner, it may be possible to realize stable generation of a vortex street, and it may be possible to realize stable agitation. Therefore, the transfer pipe 10 may have a length of 0.6 times or more the circular diameter (that is, the aspect ratio is 0.6 or more) of the cross section perpendicular to the extending direction. In addition, in order to stably generate vortex streets at all filling ratios of 10% to 90%, the transfer pipe 10 may have a length of 1.8 times or more the circular diameter of the cross section perpendicular to the extending direction (that is, the aspect ratio is 1.8 or more). In addition, an aspect ratio equal to or greater than the minimum value shown in Table 2 may be appropriately set according to the filling ratio to be set.

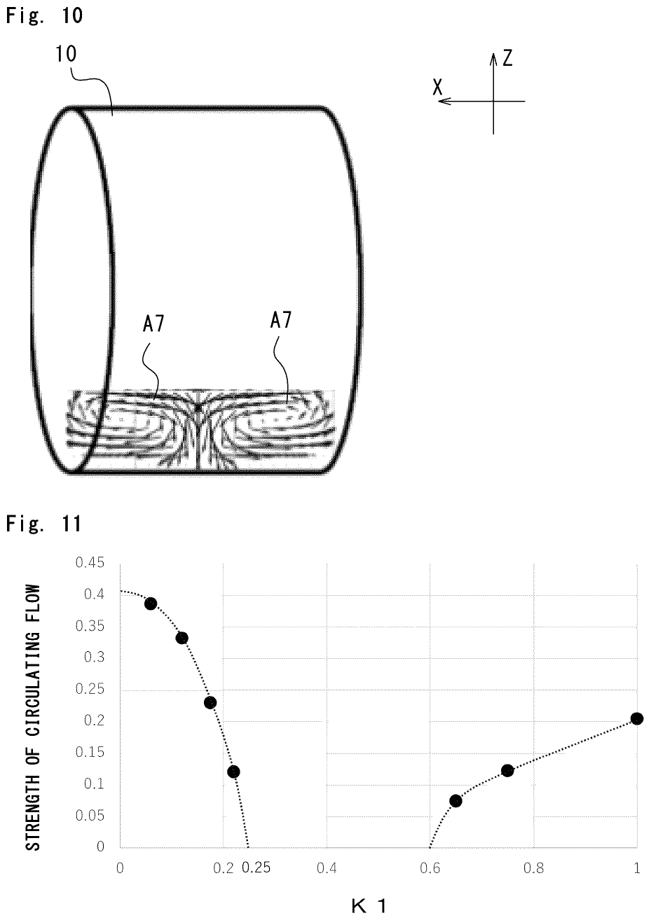

With reference to FIG. 11, a result of examining ratio K1 of the average flow velocity of the liquid in the extending direction of the transfer pipe 10 to the inner wall surface velocity in the rotation direction of the transfer pipe 10 will be described. FIG. 11 is a graph of numerical simulation results showing the relationship between the strength of the circulating flow (vortex flow) and the ratio K1 (average flow velocity/inner wall surface velocity). In the numerical simulations of FIG. 11, the viscosity of the liquid was set so that Reynolds number Re was 200, the filling ratio was set to 40%, and the average flow velocity was variously changed.

As a result, when the ratio K1 was 0.25 or less or 0.6 or more, generation of the vortex street (circulating flow) could be confirmed. In particular, when the ratio K1 was 0.25 or less, a stronger circulating flow could be confirmed as the ratio K1 was smaller, and when the ratio K1 was 0.6 or more, a stronger circulating flow could be confirmed as the ratio K1 was larger. Therefore, from the results, it could be confirmed that the agitation/transfer device 1 and the agitation/transfer method of the present embodiment may be effective when the ratio K1 is 0.25 or less or 0.6 or more. Therefore, by specifically defining the ratio K1 in this manner, it may be possible to realize stable generation of the vortex street, and it may be possible to realize stable agitation.

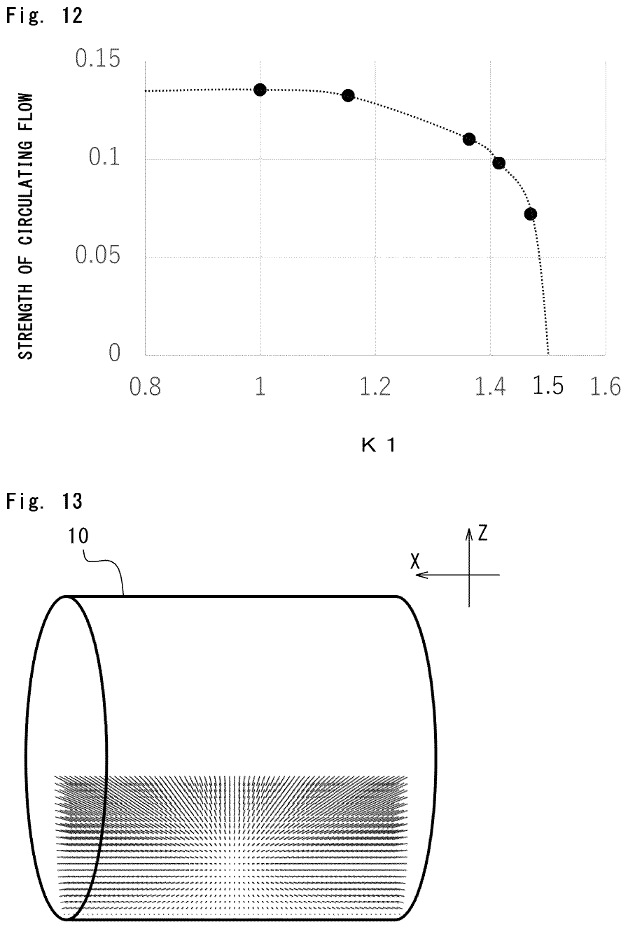

Another examined result of the ratio K1 (average flow velocity/inner wall surface velocity) of the average flow velocity of the liquid in the extending direction of the transfer pipe 10 to the inner wall surface velocity in the rotation direction of the transfer pipe 10 will be described with reference to FIG. 12.

FIG. 12 is a graph of numerical simulation results showing the relationship between the strength of the circulating flow (vortex flow) and the ratio K1. In the numerical simulations of FIG. 12, the average flow velocity was set so that the main flow Reynolds number Reₘ was 150, the filling ratio was set to be 40%, and the Reynolds number Re was variously changed. Here, the main flow Reynolds number Reₘ is a value represented by the density ρ of the liquid, the radius R of the transfer pipe 10, the average flow velocity Um in the main flow direction, and the viscosity μ of the liquid (Reₘ=ρRUₘ/μ).

As a result, when the ratio K1 was 1.5 or less, generation of the vortex street (circulating flow) could be confirmed. In particular, when the ratio K1 was 1.5 or less, a stronger circulating flow could be confirmed as the ratio K1 was smaller. Therefore, from the results, it could be confirmed that the agitation/transfer device 1 and the agitation/transfer method of the present embodiment may be effective when the ratio K1 is 1.5 or less. Therefore, by specifically defining the ratio K1 in this manner, it may be possible to realize stable generation of the vortex street, and it may be possible to realize stable agitation.

In the agitation/transfer device 1 and the agitation/transfer method of the present embodiment, particles contained in the liquid can be aggregated under predetermined conditions. The predetermined conditions may be as follows. When the at least one type of liquid to be agitated and transferred contains particles, at Reynolds number Re at which a vortex street is generated, Stokes number St in agitation is 2.7×10⁻⁵ or more (St≥2.7×10⁻⁵), and ratio K2 between terminal velocity of free fall of the particles and inner wall surface velocity in a rotation direction of the transfer pipe 10 is −0.01 or more and 0.52 or less (−0.01≤K2≤0.52). Note that, the terminal velocity of the free fall of the particle here also includes a case where the particles float (a case where the terminal velocity is negative). Specifically, a case where the ratio K2<0 indicates that the particles float.

The Stokes number St is expressed by the following formula (1). In the following formula (1), d represents the diameter of the particle, μ represents the viscosity of the liquid, ρ represents the density of the liquid, ρₚ represents the density of the particle, and ω represents the rotation velocity of the transfer pipe 10.

$$\begin{matrix}[ Math 1 ] & \\ St = \frac{{τ}_{p}}{{τ}_{f}} , {τ}_{p} = \frac{{ρ}_{p} {d}^{2}}{18 μ} , {τ}_{f} = \frac{2 π}{ω} & ( 1 )\end{matrix}$$

The ratio K2 is represented by the following formula (2). In the following formula (2), g represents gravitational acceleration, R represents the radius of the transfer pipe 10, and other parameters are the same as those shown in formula (1).

$$\begin{matrix}[ Math 2 ] & \\ K 2 = \frac{{τ}_{p} g}{R ω} ( 1 - \frac{ρ}{{ρ}_{p}} ) & ( 2 )\end{matrix}$$

A result of examining the Stokes number St will be described with reference to FIGS. 13 to 18. Specifically, when the Stokes number St is too small, aggregation of particles may be suppressed, and thus the minimum value of the Stokes number St was examined using numerical simulation. In the numerical simulation, the radius R of the transfer pipe 10 was set to 1 [cm], the viscosity μ of the liquid was set to 0.001 [Pa·s], the density ρ of the liquid was set to 1000 [kg/m³], the filling ratio was set to 40%, and the rotation velocity ω around the horizontal axis of the transfer pipe 10 was set to 4 [rad/s] (94 rpm). Accordingly, the Reynolds number Re was set to 400. In addition, in the numerical simulation, the density ρₚ of the particles was set to 1200 [kg/m³] (that is, the density ratio between the particles and the liquid was 1.2/1.0), and the number of particles was set to about 100,000. Under the conditions, the diameter d of the particle was variously changed, the time evolution of the particle field was observed, and the change in the spatial distribution of the particle with respect to the diameter d of the particle (that is, Stokes number St) was confirmed.

FIG. 13 shows an initial arrangement of particles in the numerical simulation regarding the Stokes number St. As shown, the particles are evenly arranged in the liquid.

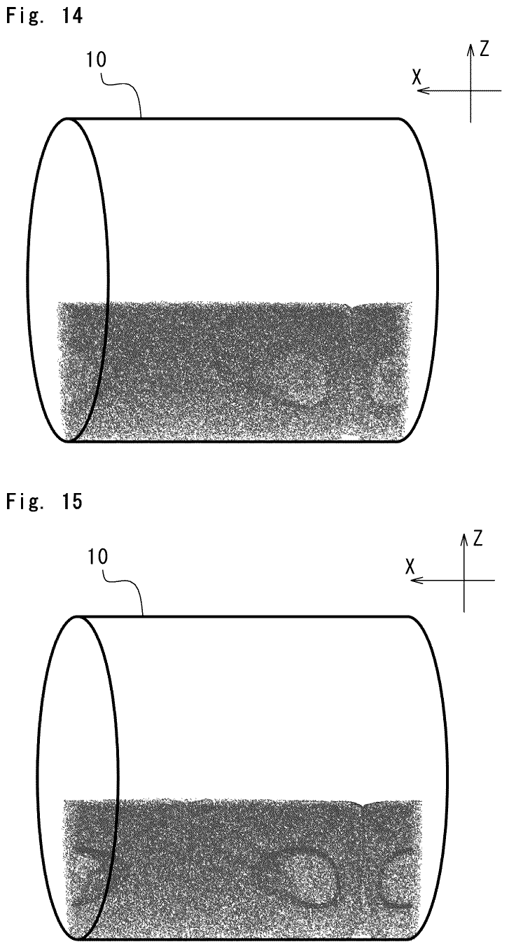

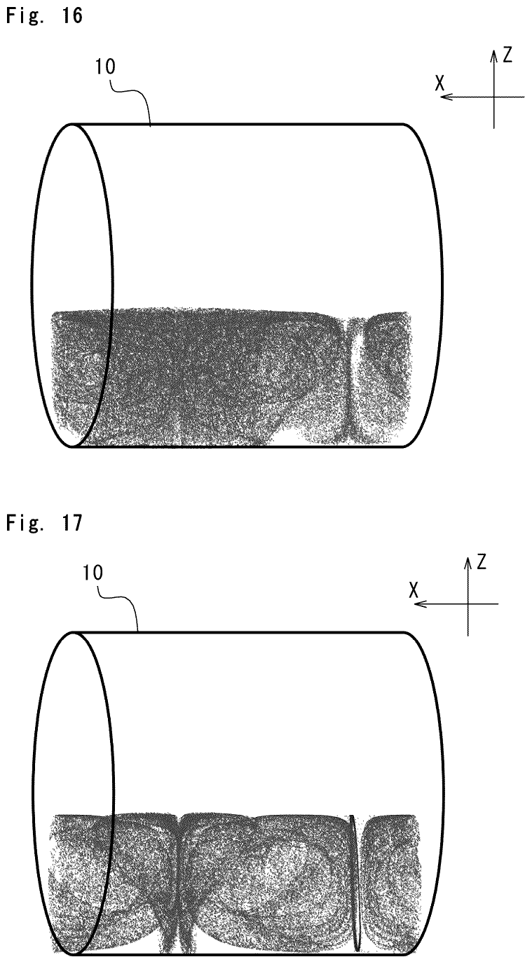

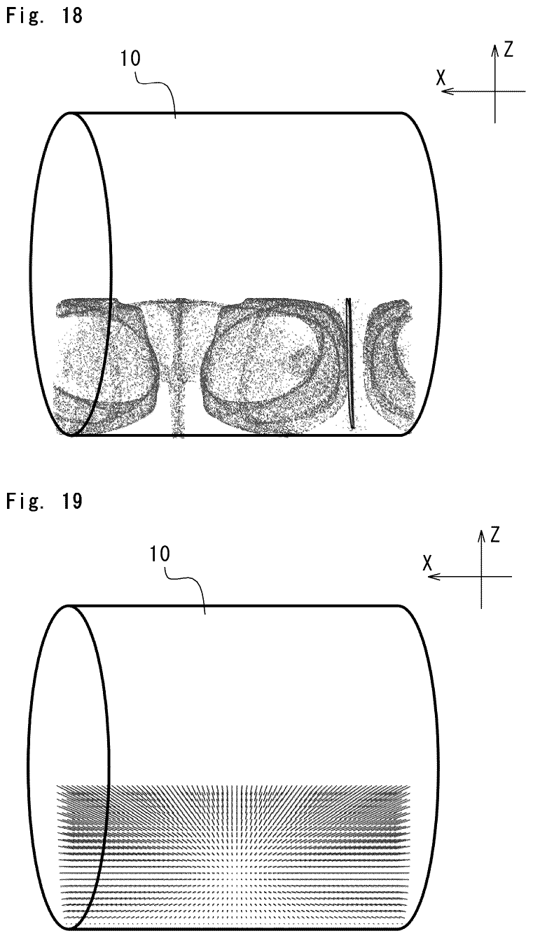

FIG. 14 shows a case where the particle diameter d is 15 [μm] (Stokes number St=9.5×10⁻⁶), FIG. 15 shows a case where the particle diameter d is 25 [μm] (Stokes number St=2.7×10⁻⁵), FIG. 16 shows a case where the particle diameter d is 50 [μm] (Stokes number St=1.1×10⁵), FIG. 17 shows a case where the particle diameter d is 100 [μm] (Stokes number St=4.2×10⁻⁴), and FIG. 18 shows a case where the particle diameter d is 200 [μm] (Stokes number St=1.7×10⁻³).

From the results shown in FIGS. 14 to 18, when the Stokes number is 2.7×10⁻⁵ or more (FIGS. 15 to 18), the density of particle distribution can be remarkably confirmed, that is, it could be confirmed that collision of particles is activated in a dense portion, and aggregation can be promoted. Therefore, for aggregation of the particles, the Stokes number St in agitation may be set to 2.7×10⁻⁵ or more (St≥2.7×10⁻⁵).

With reference to FIGS. 19 to 24, a result of examining the ratio K2 (terminal velocity of free fall of particles/inner wall surface velocity in the rotation direction of the transfer pipe 10) will be described. In the numerical simulation, the radius R of the transfer pipe 10 was set to 1 [cm], the viscosity μ of the liquid was set to 0.001 [Pa·s], the density ρ of the liquid was set to 1000 [kg/m³], the filling ratio was set to 40%, and the rotation velocity ω around the horizontal axis of the transfer pipe 10 was set to 4 [rad/s] (94 rpm). Accordingly, the Reynolds number Re was set to 400. In addition, in the numerical simulation, the particle diameter d was set to 100 [μm], and the number of particles was set to about 100,000. Under the conditions, the density ρₚ of the particles was variously changed, the time evolution of the particle field was observed, and the change in the spatial distribution of the particles with respect to the density ρₚ of the particles (that is, the ratio K2) was confirmed.

FIG. 19 shows the initial arrangement of the particles in a numerical simulation with respect to the ratio K2. As shown, the particles are evenly arranged in the liquid.

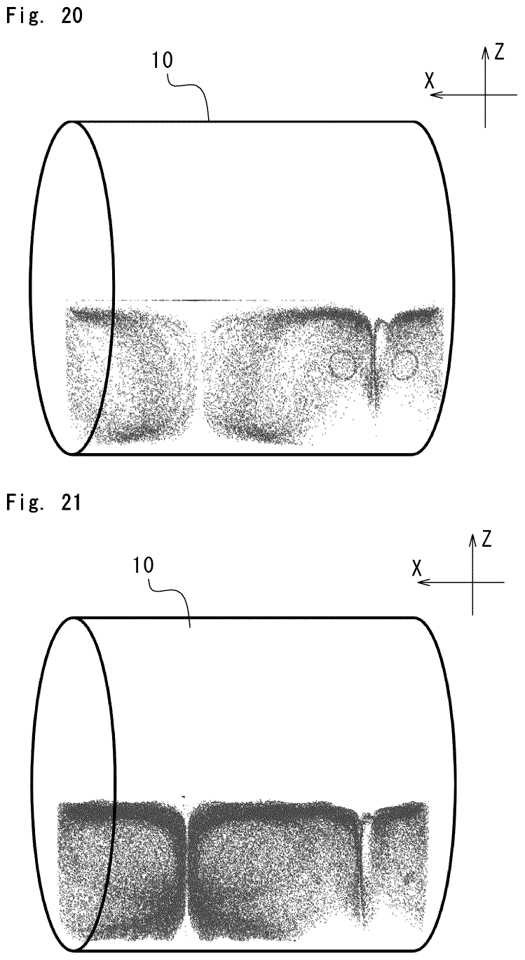

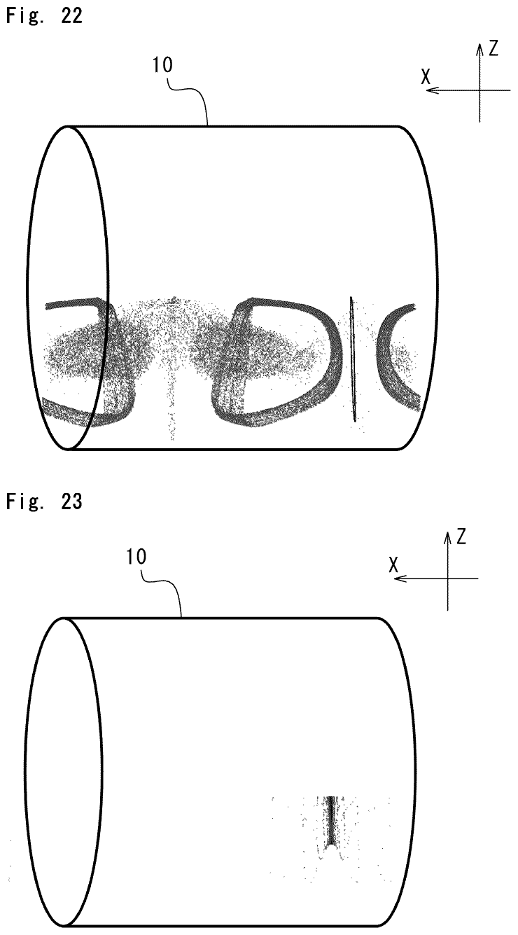

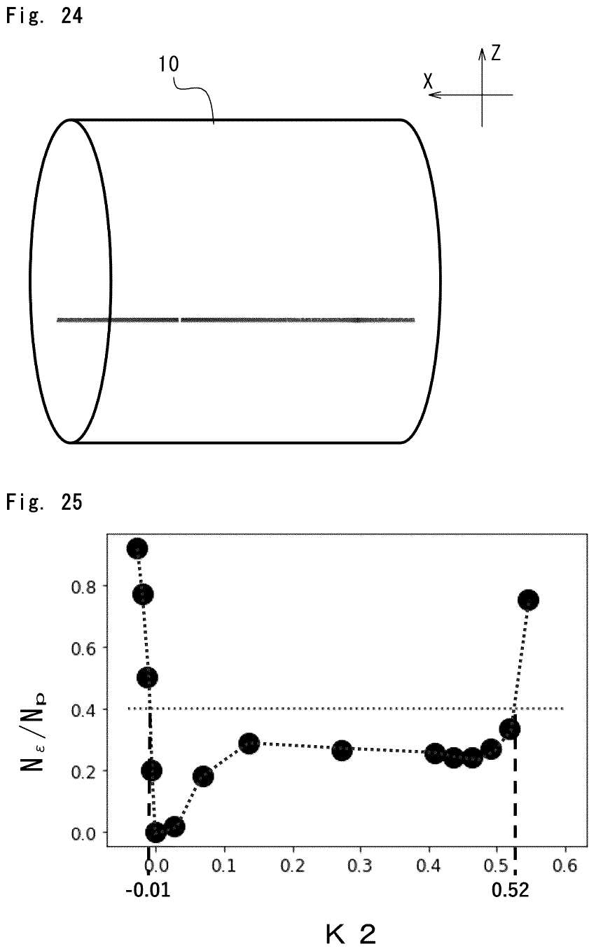

FIG. 20 shows a case where the density ρₚ of the particles is 850 [kg/m³] (K2=−0.02), FIG. 21 shows a case where the density ρₚ of the particles is 950 [kg/m³] (K2=−0.0068), FIG. 22 shows a case where the density ρₚ of the particles is 1500 [kg/m³] (K2=0.068), FIG. 23 shows a case where the density ρₚ of the particles is 3000 [kg/m³] (K2=0.27), and FIG. 24 shows a case where the density ρₚ of the particles is 5000 [kg/m³] (K2=0.55).

From the results shown in FIGS. 20 to 24, the inhomogeneity in the spatial distribution of particles is observed in all cases. However, since the spatial distribution of the particles in the depth direction cannot be confirmed only from these results, the spatial distribution of the particles in the cross section perpendicular to the rotation axis of the transfer pipe 10 was also confirmed as follows.

FIG. 25 is a graph showing a result of confirming the proportion of particles in the vicinity of the inner wall surface or the liquid surface of the transfer pipe 10. Specifically, FIG. 24 is a graph in which the number of particles within 100 [μm] from the inner wall surface or the liquid surface of the transfer pipe 10 is N_{ε}, the number of all particles is Nₚ, and the dependency of N_{ε}/Nₚ on the ratio K2 is confirmed.

Referring to FIG. 25, when the ratio K2 is −0.01 or more and 0.52 or less (−0.01≤K2≤0.52), Nε/Nₚ is a threshold 0.4 or less. That is, in this range, it could be confirmed that 60% or more of the particles were not located in the vicinity of the inner wall surface or the liquid surface, and were densely located in the central region of the liquid. Therefore, the ratio K2 may be set to −0.01 or more and 0.52 or less (−0.01≤K2≤0.52).

Although specific embodiments of the present invention have been described above, the present invention is not limited to the above embodiments, and various modifications can be made within the scope of the present invention.

For example, the shape of the transfer pipe 10 is not limited to a circular pipe, and may be a pipe having any shape having a smooth inner surface shape. Therefore, the shape of the cross section perpendicular to the extending direction of the transfer pipe 10 may be circular as in the above embodiment, or may be a shape other than circular. For example, the shape of the cross section perpendicular to the extending direction of the transfer pipe 10 may be an elliptical shape or a donut shape. In addition, the thickness (diameter) of the transfer pipe 10 does not need to be uniform, that is, may vary depending on the position in the extending direction. For example, the transfer pipe 10 may have a tapered shape that narrows from one end toward the other end.

In addition, the transfer pipe 10 may be arranged not only horizontally but also substantially horizontally, and for example, an inclination of about several degrees from the horizontal direction is allowed. In addition, the rotation axis RA and the central axis of the transfer pipe 10 do not need to perfectly match, and may be slightly shifted (eccentric).

In addition, the configuration of the rotation mechanism 20 can be variously considered other than the above embodiment, and any configuration capable of rotating the transfer pipe 10 about the rotation axis RA can be adopted.

### REFERENCE SIGNS LIST

1 Agitation/transfer device
10 Transfer pipe
11 Support member
11a Through hole
12 Bearing
13 Connection component
20 Rotation mechanism
21 Motor
22 Belt
23, 24 Pulley
30 Flow device
40 Control device
G Floor surface
RA Rotation axis

1. An agitation/transfer method comprising:
preparing a transfer pipe extending in a horizontal extending direction;
causing at least one type of liquid to be agitated and transferred to flow and be transferred in the transfer pipe at Reynolds number in a predetermined range and a filling ratio in a predetermined range; and
agitating the at least one type of liquid by rotating the transfer pipe about the extending direction and generating a vortex street in the at least one type of liquid, wherein
the transfer pipe is a circular pipe having a smooth inner surface.

2. The agitation/transfer method according to claim 1, wherein the filling ratio in the predetermined range is 10% or more and 90% or less.

3. (canceled)

4. The agitation/transfer method according to claim 1, wherein the transfer pipe is a circular pipe having a constant diameter.

5. The agitation/transfer method according to claim 4, wherein the transfer pipe has a length of 0.6 times or more a circular diameter of a cross section perpendicular to the extending direction.

6. The agitation/transfer method according to claim 4, wherein the Reynolds number in the predetermined range is 98 or more.

7. The agitation/transfer method according to claim 4, wherein
the at least one type of liquid to be agitated and transferred contains particles, and
Stokes number in the agitation is 2.7×10⁻⁵ or more, and ratio between terminal velocity of free fall of the particles and inner wall surface velocity in a rotation direction of the transfer pipe is −0.01 or more and 0.52 or less.

8. An agitation/transfer device comprising:
a transfer pipe that extends in a horizontal extending direction and causes at least one type of liquid to be agitated and transferred to flow and be transferred at a filling ratio in a predetermined range and Reynolds number in a predetermined range; and
a rotation mechanism that agitates the at least one type of liquid by rotating the transfer pipe about the extending direction and generating a vortex street in the at least one type of liquid, wherein
the transfer pipe is a circular pipe having a smooth inner surface.

9. The agitation/transfer device according to claim 8, wherein the filling ratio in the predetermined range is 10% or more and 90% or less.

10. (canceled)

11. The agitation/transfer device according to claim 8, wherein the transfer pipe is a circular pipe having a constant diameter.

12. The agitation/transfer device according to claim 11, wherein the transfer pipe has a length of 0.6 times or more a circular diameter of a cross section perpendicular to the extending direction.

13. The agitation/transfer device according to claim 11, wherein the Reynolds number in the predetermined range is 98 or more.

14. The agitation/transfer device according to claim 13, wherein
the at least one type of liquid to be agitated and transferred contains particles, and
the Stokes number in the agitation is 2.7×10⁻⁵ or more, and ratio between terminal velocity of free fall of the particles and inner wall surface velocity in a rotation direction of the transfer pipe is −0.01 or more and 0.52 or less.
